(19) United States
(12) Patent Application Publication
(10) Pub. No.: US 2016/0205558 A1
(43) Pub. Date: Jul. 14, 2016

(54) INTEGRATED INFRASTRUCTURE

(71) Applicant: Honeywell International Inc., Morristown, NJ (US)

(72) Inventors: Cory Grabinger, Maple Grove, MN (US); Miroslav Mikulica, Brno (CZ); William Bray, Minneapolis, MN (US)

(21) Appl. No.: 14/592,402

(22) Filed: Jan. 8, 2015

(51) Int. Cl. H04W 16/02

(52) U.S. Cl. CPC H04W 16/02; H04W 84/22

(57) ABSTRACT

A single infrastructure arrangement resulting from merging two or more sets of infrastructure. For example, an arrangement may incorporate an infrastructure or a set of infrastructure incorporating components with wireless access points and one or more sets of infrastructure with components having functional purposes, for example, such as those of heating, ventilation and air conditioning systems, smoke detection, security, and so on. An integrated infrastructure may encompass components having the functional purposes and the wireless access points.

This application claims the benefit of Provisional Patent application Ser. No. 62/025,412, filed Jul. 16, 2014, and entitled “A Controller with Integrated Power over Ethernet Network Switch”. Provisional Patent Application Ser. No. 62/025,412, filed Jul. 16, 2014, is hereby incorporated by reference.

### BACKGROUND

The present disclosure pertains to local area networks and particularly pertains to accesses of the local area networks.

### SUMMARY

The disclosure may reveal a single infrastructure arrangement resulting from merging two or more sets of infrastructure. For example, an arrangement may incorporate an infrastructure or a set of infrastructure incorporating components with wireless access points and one or more sets of infrastructure with components having functional purposes, for example, such as those of heating, ventilation and air conditioning systems, smoke detection, security, and so on. An integrated infrastructure may encompass components having the functional purposes and the wireless access points.

### BRIEF DESCRIPTION OF THE DRAWING

FIG. 1 is a diagram of an example multi-infrastructure arrangement having one set of infrastructure, for instance, a heating, ventilation and air conditioning network and one set of infrastructure for a user application network;

FIG. 2 is a diagram of an illustrative example single infrastructure arrangement resulting from merging two or more sets of infrastructure, such as those illustratively shown in the diagram of FIG. 1; and

FIG. 3 is a diagram like that of FIG. 2 but incorporating instances of connection to the infrastructure arrangement.

### DESCRIPTION

The present system and approach may incorporate one or more processors, computers, controllers, user interfaces, wireless and/or wire connections, and/or the like, in an implementation described and/or shown herein.

This description may provide one or more illustrative and specific examples or ways of implementing the present system and approach. There may be numerous other examples or ways of implementing the system and approach.

In commercial buildings, there may be multiple sets of infrastructure installed from network physical perspective. There may be one set of infrastructure for a heating, ventilation and air conditioning (HVAC) network, one set of infrastructure for a security network, one set of infrastructure for a user application network, and so on. Multiple sets of infrastructure may require separate contractors, separate logistics and a large cost to implement these systems today.

The present approach may solve the multiple infrastructure issue by coupling the HVAC network, as an illustrative example, one or more user application networks (for certain sized buildings). HVAC networks going forward may require additional bandwidth than the current networks can provide, so there may be a trend for HVAC infrastructure to move towards, for instance, an Ethernet IP based network. As this happens, Ethernet IP (internet protocol) access may be available at different components of the HVAC system. As this access comes down to an HVAC wall module, it may be possible to put Wi-Fi™ access points in wall modules around a building to supply internet access using the HVAC infrastructure and to eliminate multiple sets of infrastructure. Wi-Fi may be a local area wireless technology that allows an electronic device to exchange data or connect to the internet using radio frequency (RF) waves, such as Wi-Fi. Wi-Fi may be regarded as a “wireless local area network” (WLAN). Other local area wireless technology may allow an electronic device to exchange data or connect to the internet using radio waves may incorporate ZigBee™, Bluetooth™, WiMax™, NFC (near field communication), and the like.

This present approach may be brought to practice by adding a Wi-Fi access point to a power over Ethernet (POE) wall module. Alternatively, power may be brought in separately by wire or with one or more local sources.

The Wi-Fi user application network can be (but does not necessarily need to be) routed through a VLAN (virtual local area network) so that network isolation can be maintained. With VLAN, network topology is not necessarily separated physically but may be separated virtually. There may be several VLANs and one physical LAN. The VLAN may be regarded as a network of computers that behave as if they are connected to the same wire even though they may actually be physically located on different segments of a LAN. A VLAN may be configured through software rather than hardware which makes it flexible. One advantage of a VLAN may be when a computer is physically moved to another location, it can stay on the same VLAN without a hardware reconfiguration.

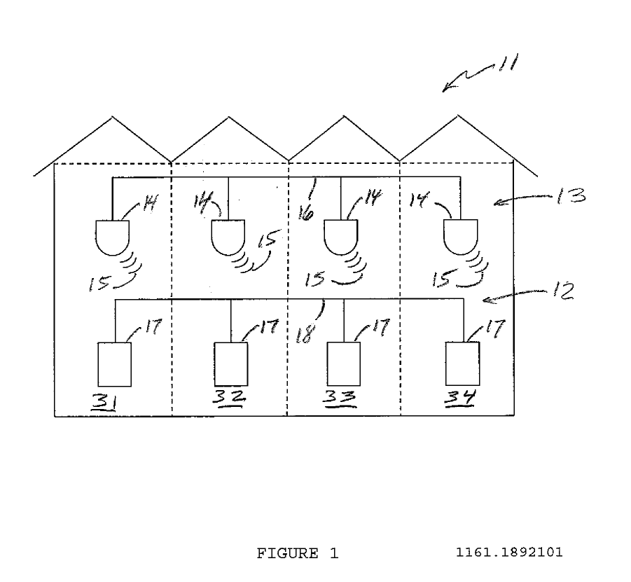

FIG. 1 is a diagram of a multi infrastructure arrangement 11 having one set 12 of infrastructure for a HVAC network and one set 13 of infrastructure for a user application network. Set 13 of infrastructure may have components 14 that provide Wi-Fi access points 15. Components 14 may be connected to a LAN 16. Set 12 of infrastructure may have, for instance, items 17 connected to a LAN 18. Wall modules or thermostats may be items 17 connected to LAN 18. Other kinds of HVAC items 17 may be connected to LAN 18. Items 17 may incorporate security or other types of components on LAN 18, or there may be another LAN for an additional set of infrastructure of another type of components. Each of the components 14 and items 17 may be situated in spaces 31, 32, 33 and 34, respectively. Spaces 31-34, for example, may be shops, stores, restaurants, or the like, in a strip mall.

With access points 15 at components 14, one may connect with a wireless item, such as a laptop, desktop, smart phone, or other wireless item, via Wi-Fi, or other wireless medium, to a router at component 14. LAN 16 may be connected to an internet cable, and thus a user of a wireless item connecting with Wi-Fi of component 14 may go to a site on the internet via LAN 16. LAN 16 may be, for example, an Ethernet. There may be electrical power on the Ethernet (POE) that can be provided to components 14. Likewise, LAN 18 may be an Ethernet with power that can be provided to items 17.

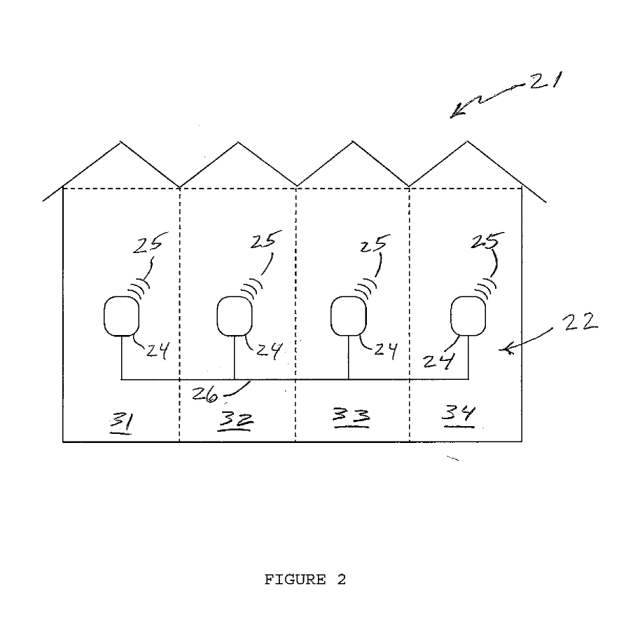

FIG. 2 is a diagram of an illustrative example having a single infrastructure arrangement 21 merging two or more sets of infrastructure, such as sets 12 and 13 of arrangement 11 of FIG. 1, into one set 22 of infrastructure. Arrangement 21 may offer an advantage of greater bandwidth for items or components 24 than those items 17 of set 12. Set 22 may have items 24 connected to a LAN 26. Items 24 may be representative of items 17 of set 12 but further have Wi-Fi access points 25 for connection to the internet like those access points 15 of components 14 of set 13 in FIG. 1. Items 24 may be connected to a LAN 26. LAN 26 may be, for instance, an Ethernet cable having POE for providing power to items 24.

LAN 26 may be used for different functions with separation effected by software. For instance, components 24 may incorporate HVAC wall modules or thermostats to result in an HVAC specific infrastructure. Wall modules may receive HVAC information from HVAC sensors and respond, for example, according to setpoints at the wall module and the information, as needed, by sending HVAC signals to control one or more actuators of a mechanism that will act to cause the information to be in accordance with the setpoints. The HVAC information and signals may be received and sent in a form of individual packets as part of communications for an HVAC infrastructure on LAN 26. Communications to and from HVAC items or components may be via a LAN 26 cable or via a WLAN (wireless local area network) such as Wi-Fi. However, it may be noted that a WLAN could be less secure than a wired connection such as Ethernet. Communications consisting of other packets of information and signals for one or more various functions, such as security, retailing, accounting for transactional activity, and so on, of the merged or combined infrastructure, may be imparted on a LAN 26 cable or on a Wi-Fi access point 25 for communication to and from items, device or components of the respective function. Separation of packets of the multiple functions may be performed with software and processing of a computer or controller. A VLAN (virtual LAN) may be incorporated. If there is a security issue among different functions and connections, a VLAN may be incorporated for Wi-Fi and another VLAN for a function such as HVAC, and so on. A strict or air gap separation among different functions and connections, may incorporate separate physical LANs.

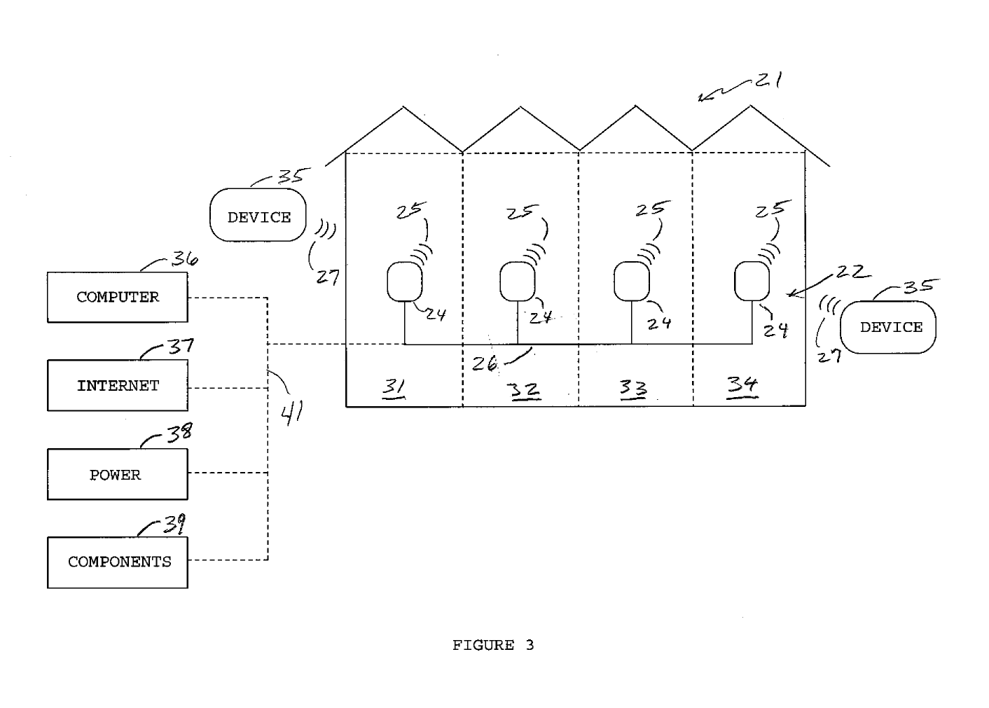

FIG. 3 is a diagram like that of FIG. 2 but incorporating instances of connection to arrangement 21. Wireless devices 35 may have a wireless connection 27 with access points 25 of items 24. Computer 36, internet 37, power 38 and/or components 39 may have one or more connections 41 with arrangement 21. One or more connections 41 may be wired or wireless to LAN 26, together or separately to the one or more items 24. One or more VLANs may be conveyed on LAN 26. Computer 36 may comprise software for the one or more VLANs.

To recap, a wall module arrangement with integrated infrastructure level radio frequency (RF) access points, may incorporate a local area network, one or more components for a heating, ventilation and air conditioning system, connected to the local area network, and one or more RF access points connected to the local area network.

One or more RF access points may be integrated in the one or more components for a heating, ventilation and air conditioning system, respectively. The local area network, the one or more components, and the one or more RF access points may receive power from one or more items selected from a group consisting of power over the network, power provided by a wired connection to a remote source, and power provided by a local source. The one or more RF access points may provide access to an internet via the local area network.

The one or more RF access points may be selected from a group consisting of Wi-Fi, ZigBee, Bluetooth, WiMax and NFC access points.

The local area network may incorporate one or more virtual local area networks.

The one or more components for a heating, ventilation and air conditioning system may receive information from sensors. The one or more components for a heating, ventilation and air conditioning system may send out signals to control actuators.

The local area network may incorporate an Ethernet.

The one or more components for a heating, ventilation and air conditioning system may be selected from a group consisting of wall modules, thermostats, temperature sensors, controllers, air handlers, humidifiers, boilers, sensors, dehumidifiers, air conditioners, chillers, and user interfaces.

An approach for integrating two or more sets of infrastructure, may incorporate selecting a first set of infrastructure having one or more information technology components having one or more wireless access points, respectively, connected to a first local area network; selecting a second set of infrastructure having one or more heating, ventilation and air conditioning components connected to a second local area network; and integrating the first set of infrastructure and the second infrastructure into a third set of infrastructure incorporating one or more heating, ventilation and air conditioning components having wireless access points of the one or more information technology components, respectively.

The third infrastructure may be connected to a third local area network selected from a group consisting of the first local area network, the second local area network and another local area network.

The wireless access points may be selected from a group consisting of Wi-Fi, ZigBee, Bluetooth, WiMax and NFC access points.

The one or more heating, ventilation and air conditioning components may be selected from a group consisting of wall modules, thermostats, temperature sensors, controllers, air handlers, humidifiers, boilers, sensors, dehumidifiers, air conditioners, chillers, and user interfaces.

The one or more information technology components may be selected from a group consisting of routers, switches, servers, wireless access point electronics, and interfaces.

The third local area network may incorporate power over network cabling to provide power to the third infrastructure.

The third local area network may incorporate one or more virtual local area networks.

The third local area network may incorporate an Ethernet.

The Ethernet may incorporate power over the Ethernet cabling to provide power to the third infrastructure.

An integrated infrastructure system may incorporate a local area network, and one or more components connected to the local area network. The one or more components may incorporate one or more RF access points, respectively, connected to the local area network.

The one or more components may be selected from a group consisting of wall modules, thermostats, temperature sensors, controllers, air handlers, humidifiers, boilers, sensors, dehumidifiers, air conditioners, chillers, and user interfaces.

The one or more RF access points may be supported with one or more information technology components, respectfully. The one or more information technology components may be selected from a group consisting of routers, switches, servers, and interfaces.

The one or more components may provide processing to enable signals to and from the one or more RF access points and signals to and from the one or more components on the same local area network. The one or more components may be selected from a group consisting of components that are of, integral to, or part of security systems, retail systems, lighting systems, HVAC systems, smoke detection systems, and human resource management systems.

The local area network may incorporate one or more virtual local area networks. The one or more virtual local networks may convey signals for one or more systems, respectively, selected from a group consisting of security systems, retail systems, lighting systems, HVAC systems, smoke detection systems, and human resource management systems.

The local area network may incorporate power over cabling of the local area network.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A wall module arrangement with integrated infrastructure level radio frequency (RF) access points, comprising:
a local area network;
one or more components for a heating, ventilation and air conditioning system, connected to the local area network; and
one or more RF access points connected to the local area network; and
wherein:
one or more RF access points are integrated in the one or more components for a heating, ventilation and air conditioning system, respectively;
the local area network, the one or more components, and the one or more RF access points receive power from one or more items selected from a group consisting of power over the network, power provided by a wired connection to a remote source, and power provided by a local source; and
the one or more RF access points provide access to an internet via the local area network.

2. The arrangement of claim 1, wherein the one or more RF access points are selected from a group consisting of Wi-Fi, ZigBee, Bluetooth, WiMax and NFC access points.

3. The arrangement of claim 1, wherein the local area network comprises one or more virtual local area networks.

4. The arrangement of claim 1, wherein:
the one or more components for a heating, ventilation and air conditioning system receive information from sensors; and
the one or more components for a heating, ventilation and air conditioning system send out signals to control actuators.

5. The arrangement of claim 1, wherein the local area network comprises an Ethernet.

6. The arrangement of claim 1, wherein the one or more components for a heating, ventilation and air conditioning system are selected from a group consisting of wall modules, thermostats, temperature sensors, controllers, air handlers, humidifiers, boilers, sensors, dehumidifiers, air conditioners, chillers, and user interfaces.

7. A method for integrating two or more sets of infrastructure, comprising:
selecting a first set of infrastructure comprising one or more information technology components having one or more wireless access points, respectively, connected to a first local area network;
selecting a second set of infrastructure comprising one or more heating, ventilation and air conditioning components connected to a second local area network; and
integrating the first set of infrastructure and the second infrastructure into a third set of infrastructure comprising one or more heating, ventilation and air conditioning components having wireless access points of the one or more information technology components, respectively; and
wherein the third infrastructure is connected to a third local area network selected from a group consisting of the first local area network, the second local area network and another local area network.

8. The method of claim 7, wherein the wireless access points are selected from a group consisting of Wi-Fi, ZigBee, Bluetooth, WiMax and NFC access points.

9. The method of claim 7, wherein the one or more heating, ventilation and air conditioning components are selected from a group consisting of wall modules, thermostats, temperature sensors, controllers, air handlers, humidifiers, boilers, sensors, dehumidifiers, air conditioners, chillers, and user interfaces.

10. The method of claim 7, wherein the one or more information technology components are selected from a group consisting of routers, switches, servers, wireless access point electronics, and interfaces.

11. The method of claim 7, wherein the third local area network comprises power over network cabling to provide power to the third infrastructure.

12. The method of claim 7, wherein the third local area network comprises one or more virtual local area networks.

13. The method of claim 7, wherein the third local area network comprises an Ethernet.

14. The method of claim 13, wherein the Ethernet comprises a power over the Ethernet cabling to provide power to the third infrastructure.

15. An integrated infrastructure system comprising:
a local area network; and
one or more components connected to the local area network; and
wherein the one or more components comprise one or more RF access points, respectively, connected to the local area network.

16. The system of claim 15, wherein the one or more components are selected from a group consisting of wall modules, thermostats, temperature sensors, controllers, air handlers, humidifiers, boilers, sensors, dehumidifiers, air conditioners, chillers, and user interfaces.

17. The system of claim 15, wherein:
the one or more RF access points are supported with one or more information technology components, respectfully; and
the one or more information technology components are selected from a group consisting of routers, switches, servers, and interfaces.

18. The system of claim 15, wherein:
the one or more components provide processing to enable signals to and from the one or more RF access points and signals to and from the one or more components on the same local area network; and
the one or more components are selected from a group consisting of components that are integral to security systems, retail systems, lighting systems, HVAC systems, smoke detection systems, and human resource management systems.

19. The system of claim 15, wherein:
the local area network incorporates one or more virtual local area networks; and
the one or more virtual local networks convey signals for one or more systems, respectively, selected from a group consisting of security systems, retail systems, lighting systems, HVAC systems, smoke detection systems, and human resource management systems.

20. The system of claim 15, wherein the local area network comprises power over cabling of the local area network.
